(19) United States
(12) Patent Application Publication
(10) Pub. No.: US 2019/0261822 A1
(43) Pub. Date: Aug. 29, 2019

(54) SURFACE CLEANING APPARATUS

(71) Applicant: TTI (Macao Commercial Offshore Limited), Macau (CN)

(72) Inventors: Matthew James Ward, West Midlands (GB); Steven James Rogers, West Midlands (GB); Guy Lawrence Newsom, West Midlands (GB); Darren David Holmes, West Midlands (GB); Richard David Waters, West Midlands (GB)

(21) Appl. No.: 16/341,837

(22) PCT Filed: Oct. 12, 2017
(86) PCT No.: PCT/GB2017/053076

§ 371 Date: Apr. 12, 2019

(30) Foreign Application Priority Data
Oct. 14, 2016 (GB) 1617522.6

(51) Int. Cl. A47L 9/00; B01D 46/02; B01D 45/12; B01D 50/00

(52) U.S. Cl. CPC A47L 9/0081; B01D 46/02; B01D 2279/55; B01D 50/002; B01D 45/12

(57) ABSTRACT

A surface cleaning apparatus is described including a housing supporting a suction source including a motor with an axle which rotates a fan and a dirt collection container. The motor is positioned within a motor chamber and the motor chamber is positioned within a further chamber, and there being an opening in the motor chamber for permitting exhaust air to pass therefrom to the further chamber. The housing includes an exhaust outlet and wherein air from the motor chamber passes to the exhaust outlet around opposing sides of the motor chamber. In an alternative embodiment air from the motor chamber passes to the exhaust outlet through an air diffusing member.

### CROSS-REFERENCE TO RELATED APPLICATIONS

This application is a U.S. national phase entry of International Application No. PCT/GB2017/053076, filed Oct. 12, 2017, which claims priority to U.K. Patent Application No. 1617522.6, filed Oct. 14, 2016, the entire contents all of which are hereby incorporated by reference herein.

### BACKGROUND

This invention relates to a surface cleaning apparatus.

### SUMMARY

According to a first aspect of the invention, we provide a surface cleaning apparatus including:
a housing supporting:
   a suction source including a motor with an axle which rotates a fan; and
   a dirt collection container,
wherein the motor is positioned within a motor chamber, and wherein the motor chamber is positioned within a further chamber, and there being an opening in the motor chamber for permitting exhaust air to pass therefrom to the further chamber, wherein the housing includes an exhaust outlet and wherein air from the motor chamber passes to the exhaust outlet around opposing sides of the motor chamber.

According to a second aspect of the invention, we provide a surface cleaning apparatus including:
a housing supporting:
   a suction source including a motor with an axle which rotates a fan; and
   a dirt collection container,
wherein the motor is positioned within a motor chamber, and wherein the motor chamber is positioned within a further chamber, and there being an opening in the motor chamber for permitting exhaust air to pass therefrom to the further chamber, wherein the housing includes an exhaust outlet and wherein air from the motor chamber passes to the exhaust outlet through an air diffusing member.

Further features of the first and second aspects of the invention are set out in the appended claims.

### BRIEF DESCRIPTION OF THE DRAWINGS

Embodiments of the invention will be set out below by way of example only with reference to the accompanying figures, of which:

FIG. 1 is a perspective view of a surface cleaning apparatus;

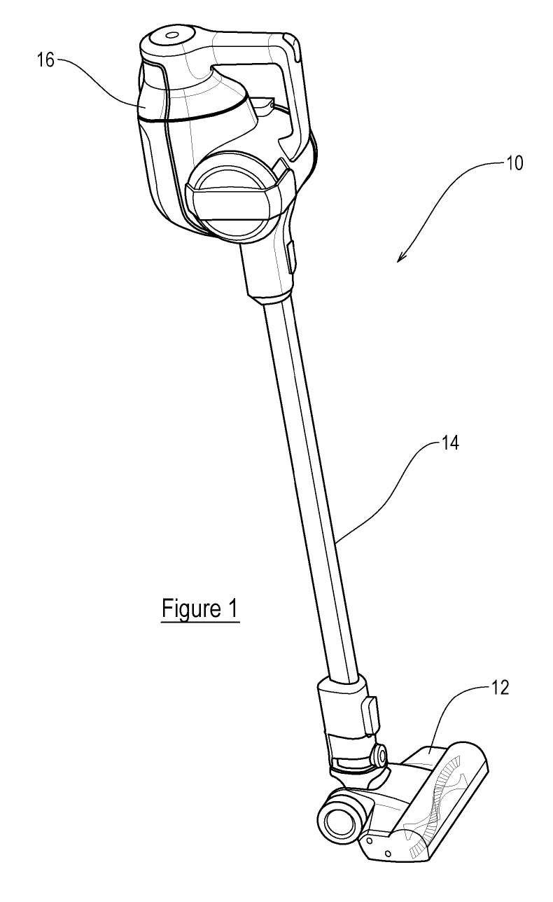

FIG. 2 is a front view of the apparatus of FIG. 1;

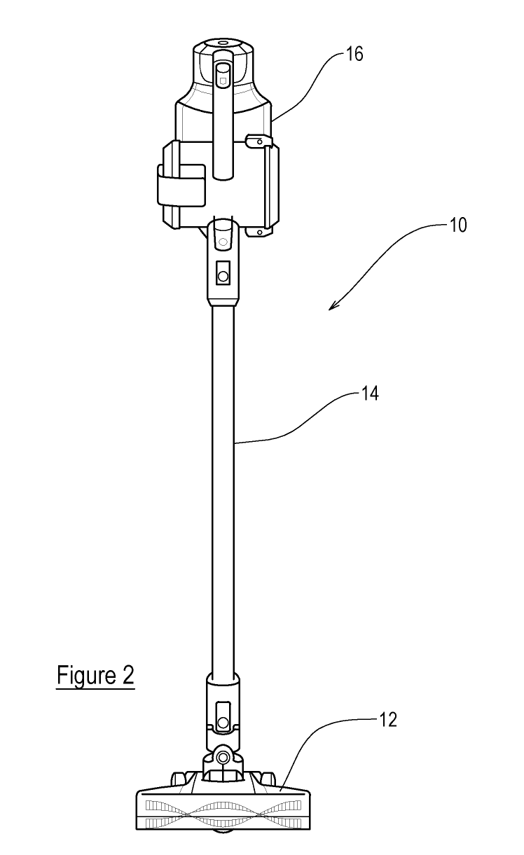

FIG. 3 is a side view of the apparatus FIG. 1;

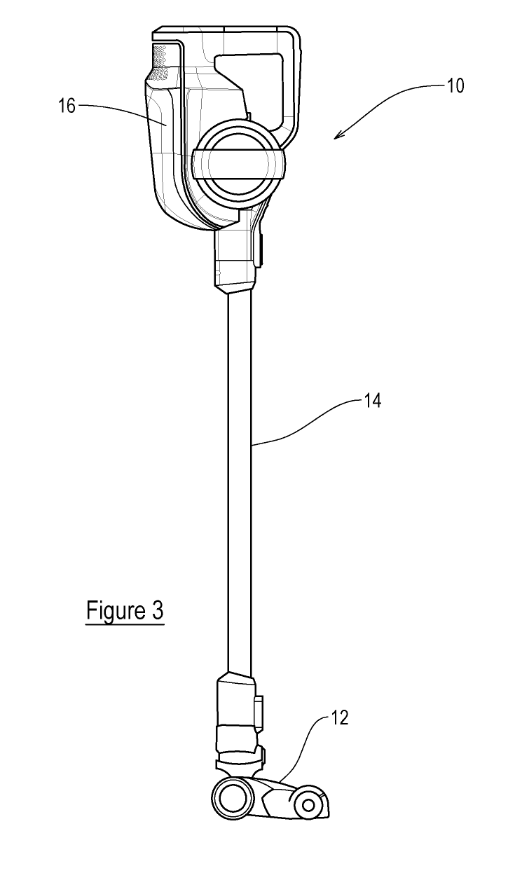

FIG. 4 is an opposite side view of the apparatus FIG. 1;

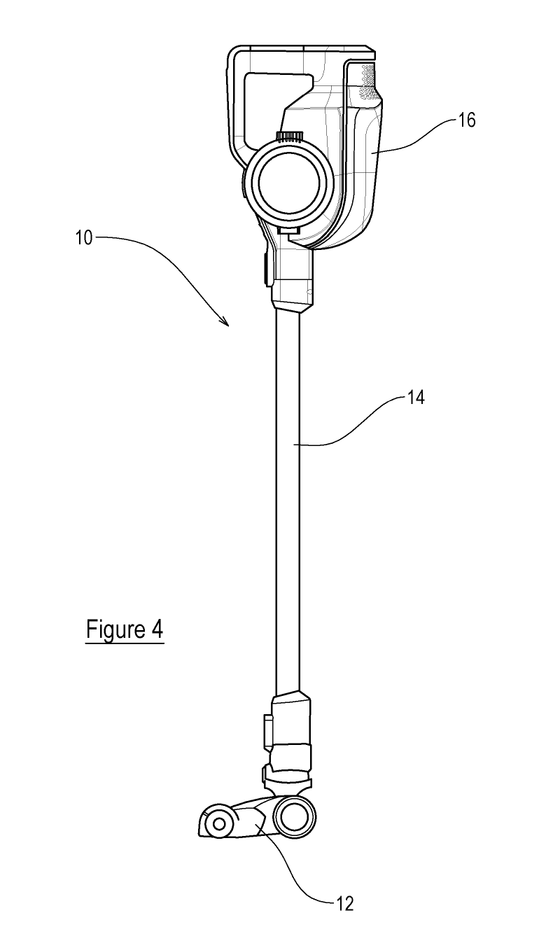

FIG. 5 is a perspective view of a housing of the apparatus of FIG. 1, which housing is operable as a handheld surface cleaning apparatus;

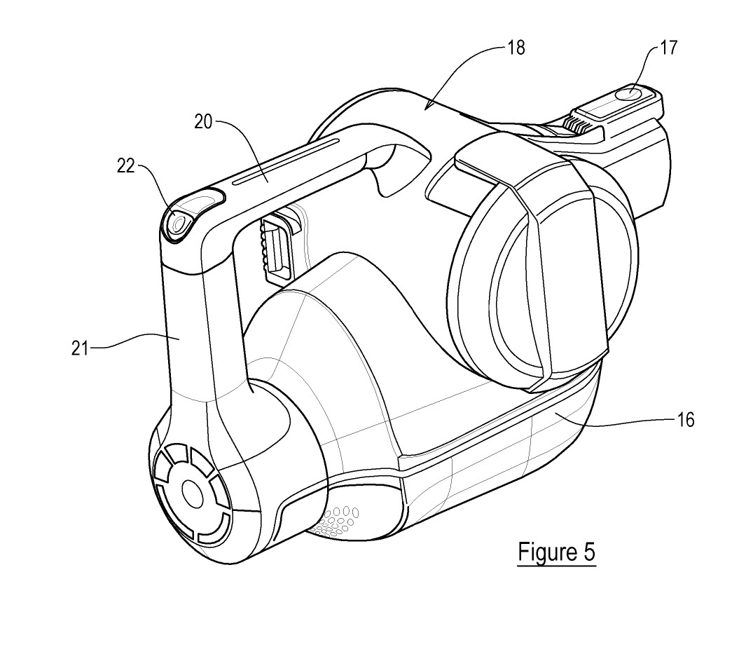

FIG. 6 is a side view of the housing of FIG. 5;

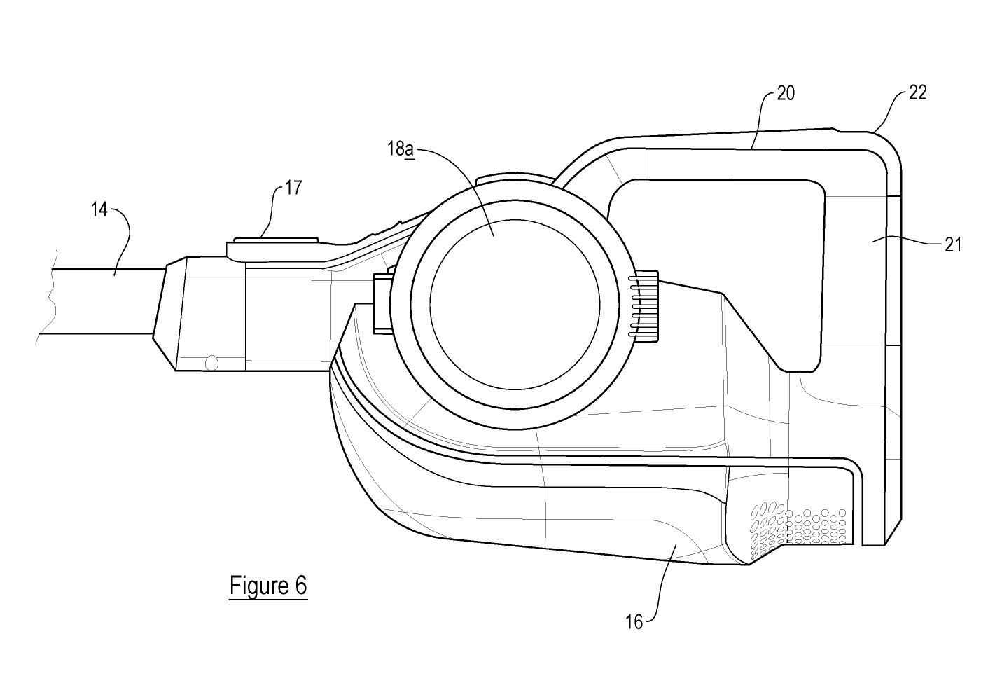

FIG. 7 is an opposite side view of the housing of FIG. 5;

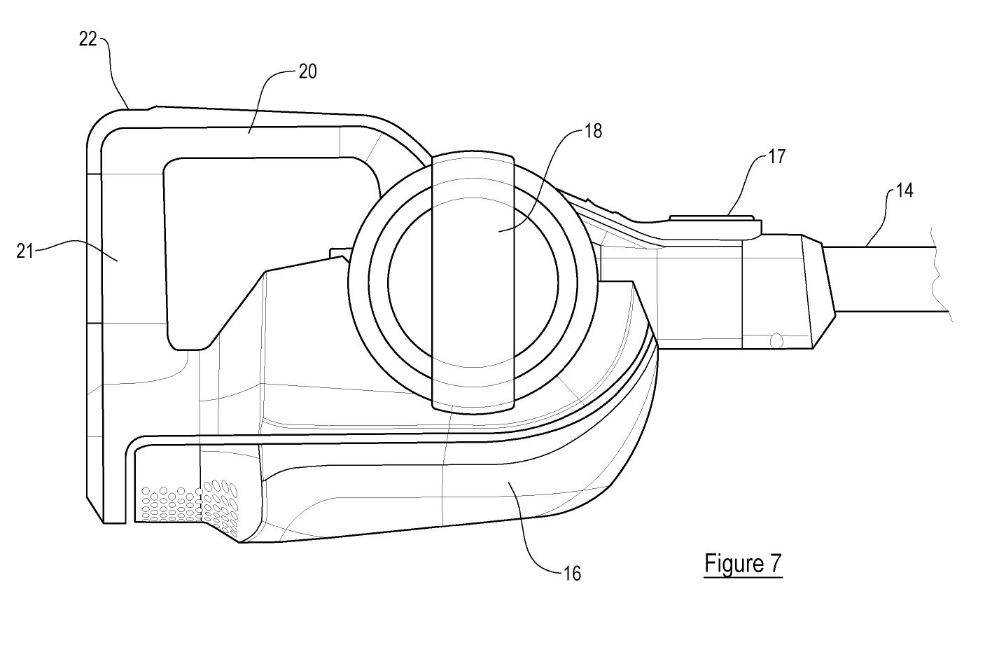

FIG. 8 is a side cross-sectional view of the housing;

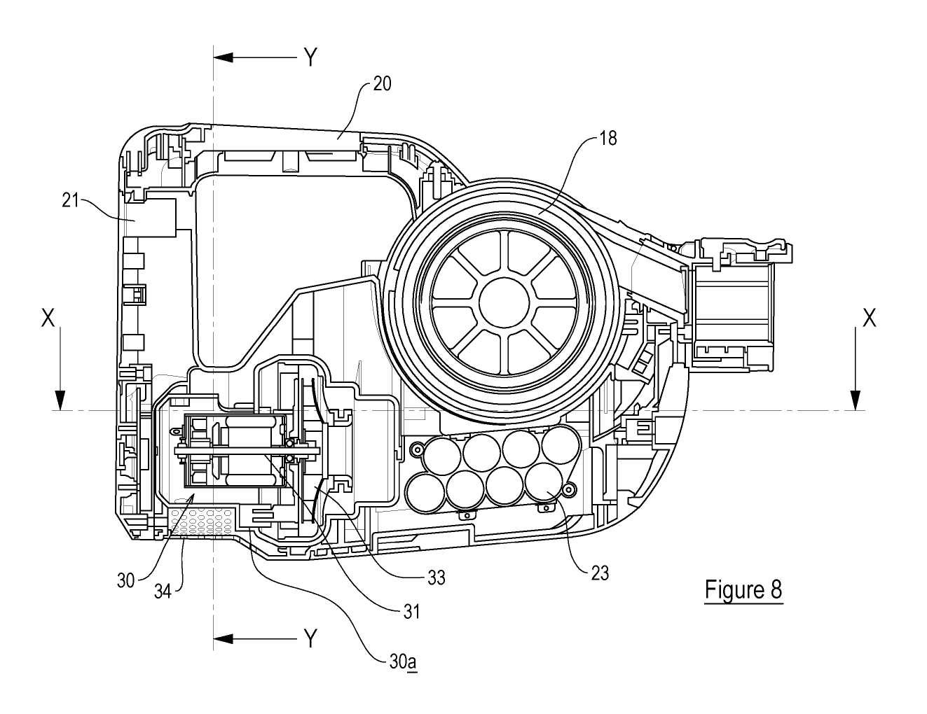

FIG. 9 is a plan cross-sectional view of the housing through the plane X-X as shown in FIG. 8;

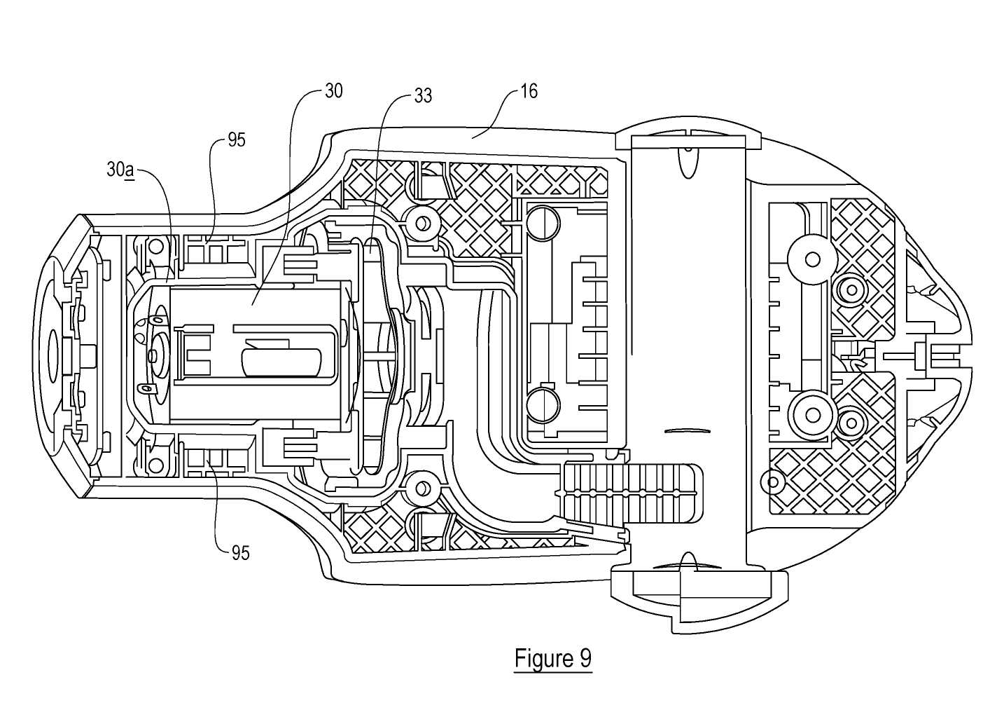

FIG. 10 is an end cross-sectional view of the housing through the plane Y-Y as shown in FIG. 8;

FIG. 11 is a perspective cross-sectional view of the housing through the plane Y-Y as shown in FIG. 8; and

FIG. 12 is a plan view of a motor chamber within the housing.

### DETAILED DESCRIPTION

Referring to the figures, these show a surface cleaning apparatus 10 in accordance with the present invention. The apparatus 10 includes a floor head 12, a housing 16 and an elongate member 14 connecting the floor head 12 to the housing 16. The housing 16 in this example is operable as a handheld surface cleaning apparatus, commonly known as a hand vac, when the elongate member 14 and floor head 12 are not connected thereto. The housing 16 supports a suction source, a dirt container 18 and a cyclonic separator. In this example the suction source is an electric motor driving a rotatable fan, but any appropriate suction source may be used. All that is necessary is for the suction source to be able to draw air through the floor head 12 and elongate member 14 towards the dirt collection container.

In this example the housing 16 supports or contains a battery 23 to provide electrical power to the suction motor and other components of the apparatus 10. In alternative embodiments, the apparatus 10 may be mains powered.

Whilst in the present embodiment the apparatus 10 includes a cyclonic separator to separate dirt from the air flowing through the apparatus 10, this is not essential. Indeed, embodiments are envisaged where the apparatus 10 includes a filter bag which collects dirt, or any other appropriate device to separate the dirt from the air. The apparatus 10 includes a pivotally moveable door 18a which enables a user to empty dirt collected within the container 18.

The elongate member 14 includes a passage for carrying dirt-laden air from the floor head 12 to the dirt collection container 18. In this example the floor head 12 includes a motor for driving a rotatable floor agitating member or brush, so the elongate member 14 includes a further passage through which electrical cables may extend to provide an electric connection between the housing 16 and the motor in the floor head.

The floor head 12 is disconnectable from the elongate member 14, so that, for example, another tool can be connected to the free end of the elongate member 14. The elongate member 14 is also disconnectable from the housing 16, by way of a manually operated switch 17. This enables the housing 16 to be used as handheld surface cleaning apparatus, with the option of being able to connect another tool to the location from where the elongate member 16 is removed.

The housing 16 includes a handle for holding the apparatus 10, said handle including first 20 and second 21 user-graspable portions which are connected to each other substantially at right-angles. A first end of the first user-graspable portion 20 is connected to the housing 16 and extends generally rearwardly away therefrom and from the elongate member 14. A first end of the second user-graspable portion 21 is connected to the housing 16 and extends generally upwardly therefrom. Respective second ends of the first 20 and second 21 user-graspable portions are connected to each other. Essentially, the first 20 and second 21 user-graspable portions form a handle which is L-shaped and which provides two locations each of which is sized such that it can be grasped fully by a hand of a user. A device 22, e.g. a switch, for turning the apparatus “on” is positioned at the connection of the second ends of the first 20 and second 21 user-graspable portions to each other.

In the present embodiment, the dirt collection container 18 is generally cylindrical and has an elongate axis A. Within the dirt collection container 18 is positioned a cyclonic separation device which also has an elongate axis coaxial with the axis A, the axis A being that about which dirt-laden air is caused to rotate as it passes through the apparatus 10. The elongate axis A is substantially horizontal in normal use. Whilst in this embodiment the elongate axes of the dirt collection container 18 and the cyclonic separation device are coaxial or substantially coaxial, they need not be. They could, for example, be parallel and offset from each other or inclined relative to each other.

As can be seen from the figures, the housing 16 supports a suction source in the form of an electric motor 30 with an axle 31 which is connected at one end to a fan 33. The axle 31 and fan 33 rotate about an axis. The motor 30 may be any appropriate motor, e.g. DC, AC, brushless. Motor exhaust air apertures 34 are provided in the housing 16 such that when the apparatus is held in an in use position, air from the exhaust outlet exits downwardly from the apparatus 10. The motor 30 is positioned within a motor chamber 30a. The motor 30, axle 31 and fan 33 are positioned such that they are central of the housing 16.

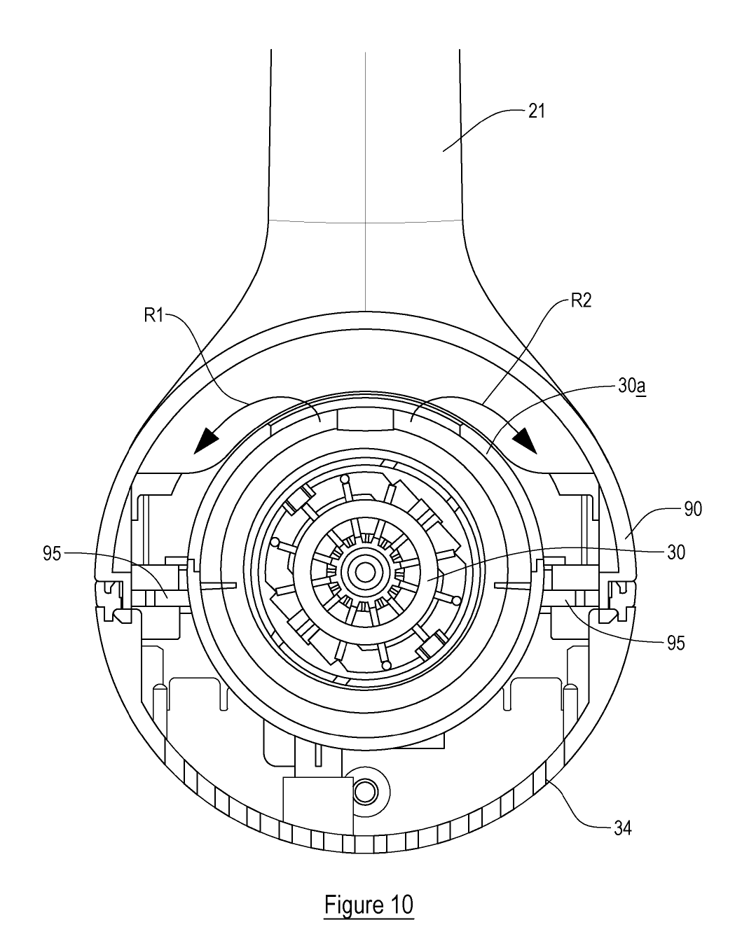

As can be seen from FIGS. 10, 11 and 12, the motor chamber 30a is positioned within a further, substantially cylindrical, chamber 90, which in this example is formed by an outer wall of the housing 16 which extends around the motor chamber 30a. There is an opening 91 in the motor chamber 30a for permitting exhaust air to pass therefrom to the further chamber 90. The opening 91 in the motor chamber 30a is positioned such that air passing therethrough is directed upwardly (when the apparatus 10 is held in normal use).

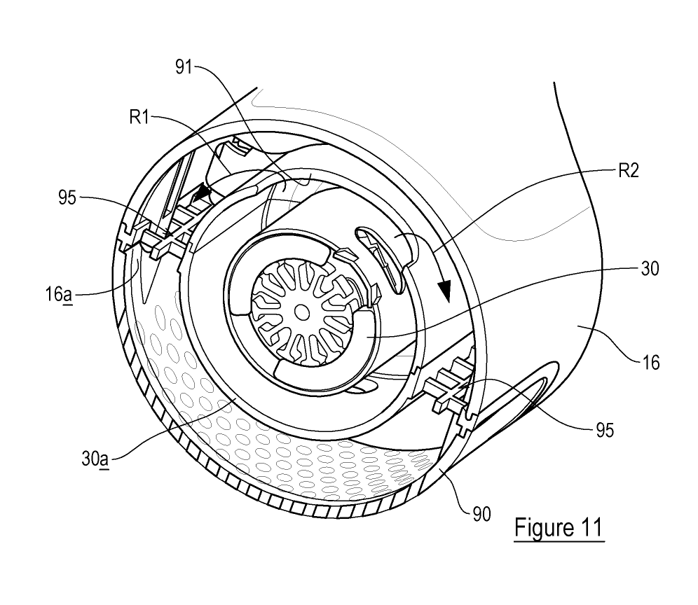

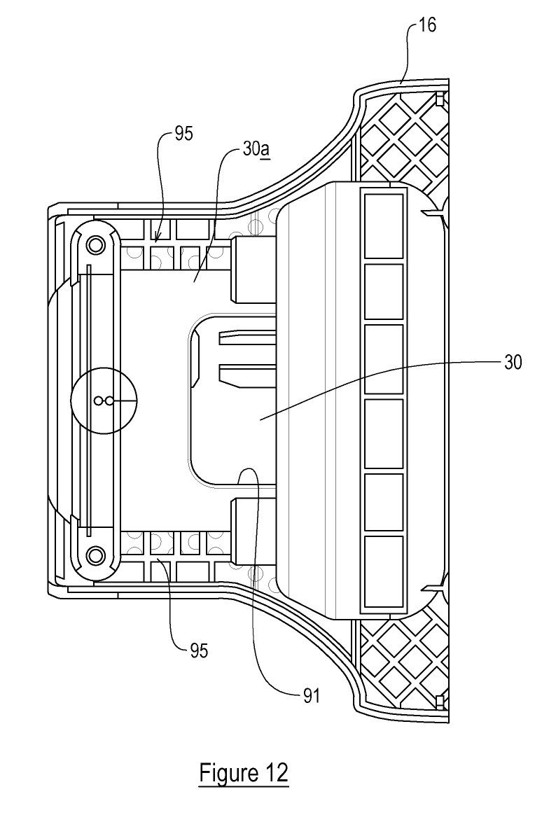

Advantageously, air from the motor chamber 30a passes to the apertures 34 around opposing sides of the motor chamber 30a (see arrows R1 and R2 in FIGS. 11 and 12). Such a splitting of the exhaust air reduces the noise emitted from the apparatus 10 in use.

Advantageously, the apparatus includes a pair of air diffusing members 95 which are positioned in the airflow between the opening 91 and the apertures 34. It should be appreciated that embodiments are envisaged with one or more than two air diffusing members. The air diffusing members 96 diffuse and disrupt the flow of air to reduce the noise emitted from the apparatus 10. In this example, each air diffusing member 95 includes a plurality of apertures through which the air passes. The apertures are, in this example, rectangular and preferably square, although they may be other shapes. They are positioned in two or more rows which are preferably parallel with each other.

The air diffusing members 95 are connected to the motor chamber 30a, at diametrically opposing sides thereof, and to an internal wall 16a of the housing 16, and each extends substantially radially away from the axis of the axle 31 of the motor. When the apparatus 10 is held in an in use position, the air diffusing members 95 extend substantially horizontally away from the motor chamber 30a. The air diffusing members 95 therefore provide some support for the motor chamber 30a within the further chamber 90.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A surface cleaning apparatus comprising:
a housing supporting
a suction source including a motor with an axle which rotates a fan; and
a dirt collection container,
wherein the motor is positioned within a motor chamber, and wherein the motor chamber is positioned within a further chamber, and there being an opening in the motor chamber for permitting exhaust air to pass therefrom to the further chamber, wherein the housing includes an exhaust outlet and wherein air from the motor chamber passes to the exhaust outlet around opposing sides of the motor chamber.

2. An apparatus according to claim 1 wherein air from the motor chamber passes to the exhaust outlet through an air diffusing member.

3. An apparatus according to claim 2 wherein the air diffusing member includes a plurality of apertures through which the air passes.

4. An apparatus according to claim 3 wherein the apertures are rectangular.

5. An apparatus according to claim 2 wherein the apertures are positioned in two or more rows parallel with each other.

6. An apparatus according to claim 2 wherein the air diffusing member is connected to the motor chamber and to an internal wall of the housing.

7. An apparatus according to claim 2 wherein the air diffusing member extends substantially radially away from an axis of the axle of the motor.

8. An apparatus according to claim 1 wherein the exhaust outlet is positioned on an underside of the housing.

9. An apparatus according to claim 1 wherein, when the apparatus is held in an in use position, air from the exhaust outlet exits downwardly from the apparatus.

10. An apparatus according to claim 2 wherein, when the apparatus is held in an in use position, the air diffusing member extends substantially horizontally away from the motor chamber.

11. An apparatus according to claim 2 wherein the apparatus includes a pair of said air diffusing members, with a portion of air from the motor chamber passing to the exhaust outlet through each of the air diffusing members.

12. An apparatus according to claim 2 wherein the air diffusing members are positioned at opposing sides of the motor chamber.

13. An apparatus according to claim 11 wherein the air diffusing members are diametrically opposed.

14. An apparatus according to claim 1 wherein the exhaust outlet includes a plurality of apertures.

15. An apparatus according to claim 2 wherein the air diffusing member supports the motor chamber within the further chamber.

16. An apparatus according claim 15 wherein the further chamber is substantially cylindrical.

17. An apparatus according to claim 1 wherein the opening in the motor chamber is positioned such that air passing therethrough is directed upwardly.

18. An apparatus according to claim 1 wherein the apparatus includes a floor head and an elongate member connecting the floor head to the housing, said elongate member including a passage for carrying dirt-laden air from the floor head to the dirt collection container.

19. An apparatus according to claim 1 wherein the apparatus includes a cyclonic separation device for separating dirt from the airflow passing through the apparatus.

20. An apparatus according to claim 1 wherein the housing includes or is connected to a handle for holding the apparatus.

21. An apparatus according to claim 18 wherein the elongate member is disconnectable from the floor head.

22. An apparatus according to claim 18 wherein the elongate member is disconnectable from the housing.

23. An apparatus according to claim 1 wherein the housing is operable as a handheld surface cleaning apparatus when the elongate member and floor head are disconnected therefrom.

24.-25. (canceled)
